(19) United States
(12) Patent Application Publication
(10) Pub. No.: US 2012/0123826 A1
(43) Pub. Date: May 17, 2012

(54) Shopping Cart Accountability Using Coupon Incentives with Participation Option

(76) Inventors: John R. French, La Mesa, CA (US); James M. Irish, San Diego, CA (US)

(21) Appl. No.: 13/275,230

(22) Filed: Oct. 17, 2011

Related U.S. Application Data
(63) Continuation-in-part of application No. 11/855,026, filed on Sep. 13, 2007, now abandoned.

(51) Int. Cl. G06Q 30/02

(52) U.S. Cl. 705/14.1

(57) ABSTRACT

A system and method encourage shopper compliance with a monitoring schedule is provided. When signing up for a customer loyalty card, a shopper is invited to participate in an incentive program. The incentive program provides more valuable benefits to the shopper compared to customers who do not opt-in to the incentive program. More valuable benefits are awarded in exchange for the shopper agreeing to an enhanced level of monitoring as part of the monitoring schedule used while the shopper is in the store. Detectors communicate shopper and cart information to a controller and a computer when the shopper retrieves a cart from a cart corral. Upon completion of the monitoring schedule, the system provides the shopper with various benefits under the incentive program as long as the shopper has opted-in to the incentive program.

This application is a continuation-in-part of application Ser. No. 11/855,026, filed Sep. 13, 2007, which is currently pending. The contents of application Ser. No. 11/855,026 are incorporated herein by reference.

### FIELD OF THE INVENTION

The present invention pertains generally to systems and methods for reducing theft of shopping carts and for reducing labor involved in collecting shopping carts. More particularly, the present invention pertains to systems that encourage the return of shopping carts to corrals by shoppers by linking the act of returning the cart to a customer loyalty program. The present invention is particularly, but not exclusively, useful as a system that identifies a shopper, the cart used by the shopper, the shopping path taken by the shopper, and the goods purchased by the shopper during a shopping visit in order to provide various incentives, to the shopper if the shopper returns the cart to the corral and opts to participate in an incentive program that provides more significant benefits than a baseline customer loyalty program.

### BACKGROUND OF THE INVENTION

At supermarkets, shopping carts are conventionally provided for the convenience of shoppers to allow large amounts of goods to be collected, paid for and unloaded at the shoppers' cars. While some shoppers voluntarily return carts to a cart return location, such as a cart corral, often shoppers leave the carts in the vicinity of where their vehicles are parked. As a result, the empty carts must be collected by store personnel and returned to the store for subsequent use. While this may appear to be a minor matter, substantial labor costs may be incurred in order to continually retrieve the carts from the parking complex. For instance, a typical store may spend from one to six man-years in the collection process, and incur additional indirect costs associated with injury and disability claims. Worldwide, labor costs associated with cart collection add up to millions of dollars.

When carts are not collected quickly enough, parking spots may be littered with carts that will discourage other shoppers from parking at the store. Also, carts dispersed throughout a parking area are not readily available for customer use. Further, damages may be incurred when shoppers strike carts with their cars. While stores can disclaim liability for damage to the cars, legal costs can still be significant in defending against baseless suits. Further, the carts themselves may be damaged.

In other cases, some carts may be removed from the store parking lot. For example, shoppers without vehicles may use the carts to transport goods back to their homes and then abandon the carts. As a result, the store may permanently lose these carts, resulting in substantial financial loss to the store owner, since each cart is a relatively expensive piece of equipment. Because it is common for shoppers to “borrow” carts to transport their purchases home or to a transit stop, store owners must contract for regular cart retrieval services. These retrieval contractors comb their neighborhoods several times per day or week, at a cost of thousands of dollars per site per year. Once off-site, carts are often taken great distances, experiencing worn wheels and other damage. Further, rough handling during the collection process often damages the retrieved carts. In addition, extra cleaning and repair may be required following retrieval. This can add thousands of dollars of additional expenses per store per year. Also, to compensate for carts that are off-site, store owners typically must maintain excess cart inventories, often 20% to 40% over their actual need, to ensure that enough carts are available during peak shopping hours. At some sites, the total of all these costs may exceed $100,000 per site.

Customer loyalty programs are currently in use in many major stores. These programs aim to garner customer loyalty by lowering prices on certain goods for members and by providing coupons or other benefits to the customer. Such programs also give the retailer an opportunity to collect valuable information regarding the shopping habits of a customer. One drawback to customer loyalty programs is that the benefits provided to the customer are often minimal and do not provide the type of individualized benefits that would tend to be more effective in encouraging customer loyalty. Furthermore, these benefits, which are most often coupons, are generally selected by a manufacturer of goods and not by the customer.

In light of the above, it is an object of the present invention to provide a system and method for encouraging the return of shopping carts to a corral by linking the return of the cart with individualized benefits selected by the shopper. Another object of the present invention is to provide a system and method that delivers targeted benefits to a shopper during a shopping visit if the shopper returned his cart to a corral after a previous shopping visit. Still another object of the present invention is to provide a system and method that collects pertinent shopper data used to better align store merchandise with shopper behavior. Yet another object of the present invention is to provide an opt-in cart return incentive that reinforces store loyally and creates a new means for advertisers to deliver specific incentives to specific shoppers, based on shopper history. It is another object of the present invention to provide an opt-in cart return incentive system and method that is easy to implement, cost effective, simple to use, and minimally inconvenient to the customer.

### SUMMARY OF THE INVENTION

In accordance with the present invention, a system is provided for encouraging a shopper to return a shopping cart to a corral at a store. It should be noted that the system is most effective or beneficial when used in conjunction with an existing customer loyalty program. The system includes a token detector, or other device, for recognizing the shopper. Specifically, the token detector reads a token, such as a frequent shopper card, that is carried by the shopper. Also, the system includes a tag detector for identifying the cart used by the shopper. Specifically, the tag detector reads a unique tag that is mounted on each cart or hand basket in the store inventory. In a certain embodiment, a single detecting device, such as an RFID reader, may incorporate both the token detector and the tag detector. Also, an incentive program is provided to shoppers who return the cart to the cart corral and have previously agreed to additional monitoring of their activities as part of a monitoring schedule developed by a retailer for a particular store.

For the present invention, the system also includes a scanner at the point-of-sale. Functionally, the scanner is able to read the token to recognize the shopper and record the goods purchased and the path taken by the shopper. Further, the system includes an activator for causing the token detector and the tag detector to acknowledge the return of the cart to the corral by the shopper. Also, the system employs a coupon dispenser for selectively providing the shopper with coupons as part of a customer loyalty program. As part of the baseline customer loyalty program, a shopper agrees to allow the retailer to monitor the purchases and purchase history of the shopper. In most cases, a shopper who is part of the baseline program will carry a loyalty card that is swiped through a device for identification purposes. In exchange, the shopper is eligible to receive shopper-specific coupons. Depending on the desired embodiment, the coupon dispenser may be mounted on each cart or at each corral to print coupons for the shopper. Alternatively, the coupon dispenser may be located elsewhere and used to print coupons that are mailed to the shopper. The coupon dispenser need not be accessible to the customer. It may be a virtual dispenser that may electronically dispense coupons to the shopper via email.

In addition to receiving the coupons as part of the customer loyalty program, the shopper will be given the option to participate (opt-in) in an incentive program when initially signing up for a customer loyalty card. It should be noted that the shopper can change his preference about participating in the incentive program at any time. Importantly, this incentive program is different than the baseline customer loyalty program that only provides the shopper with targeted coupons. By agreeing to certain conditions, the shopper will be eligible for more significant benefits or rewards. A shopper who is part of the customer loyalty program may be identified using a swipe card, an RFID tag, or a facial recognition system. The RFID tag and facial recognition systems of identification are more convenient for the shopper, and as such, are provided only to customers who participate in the incentive program. Importantly, when opting-in to the incentive program, a shopper agrees to allow the store to conduct enhanced monitoring of the shopper through a monitoring schedule. Examples of possible components used as part of the monitoring schedule may include any, or all, of the following: (1) monitoring the path the shopper travels in the store, (2) measuring the amount of time a shopper spends in particular areas of the store, or (3) measuring the amount of time a shopper spends near particular product displays. In some instances, the shopper may be able to individually select which monitoring steps he will allow. In other instances, the retailer may make them part of a monitoring schedule that cannot be broken up. As envisioned for the present invention, the retailer can customize its own incentive program. Further, in many cases, the retailer may want to adjust the incentive plan in order to attract greater shopper participation.

In addition to providing coupons to the customer as discussed above, the coupon dispenser may be configured to provide the customer with other information related to the incentive program. Such information may include being informed about eligibility for a particular benefit or a coupon that is redeemable for cash on the shopper's next visit.

In order to encourage the return of a cart to a corral by a shopper, the system includes a controller that is in wireless communication with the other system components. Functionally, the controller determines suggested goods for subsequent purchase by the shopper based on the goods recorded by the scanner and on the shopper's purchase history. And, the controller receives information collected as part of the monitoring schedule from shoppers who have opted-in to the incentive program. Also, the controller instructs the coupon dispenser to provide coupons for the suggested goods in response to acknowledgement of the return of the cart to the corral by the shopper. In certain embodiments, the coupon dispenser provides coupons to the shopper on a subsequent shopping visit to the store. It should be noted that the system can also be adapted for use with hand baskets in addition to shopping carts.

The controller also sends information regarding information collected as part of the monitoring schedule to a computer. This computer is equipped with a computer program that keeps track of customer loyalty as it relates to the incentive program. Specifically, the computer program determines whether a shopper is eligible for a benefit, and if so, which particular benefit. When the shopper is eligible for a particular benefit through the incentive program, the computer can send a signal to the coupon dispenser by way of the controller to display a message or provide a coupon that can be brought to a checkout lane for redemption. In some embodiments, the computer can also generate an email or text message that is sent to the shopper or send a signal to a store employee assisting the shopper at a checkout lane. For shoppers who choose to participate in the incentive program, various methods of benefit delivery are offered. And, the method of benefit delivery can be updated at any time.

For operation of the system, transceivers may be provided at predetermined positions throughout the store and parking lot complex. These transceivers form a communication path between the controller and the other system components. Further, the transceivers may document the path of the shopping cart through the RFID tag as it moves through the store or calculate the amount of time a shopper is spending in particular areas of the store. The transceivers accomplish this by documenting a series of date/time/location stamps associated with a particular shopper and cart (or hand basket). If a customer has opted-in to the incentive program, the controller may consider this path and time information when determining eligibility for a benefit. In order to monitor the path of the shopping cart, the transceivers include tag detectors, such as RFID receivers that monitor RFID tags mounted on the carts. As envisioned for the present invention, the level of monitoring of the activity of the shopper will be based on whether the shopper has opted-in to the incentive program.

For the present invention, various types of benefits can be provided to a shopper to encourage the shopper to return his/her cart to a cart corral. Specifically, in addition to the coupons that may be mailed or emailed to the shopper who is part of a customer loyalty program, shoppers who have opted-in to the incentive program may receive more valuable benefits. These benefits may be cash payments, a product from a catalog provided by the retailer, or a charitable donation. These are just exemplary benefits, and a store can provide any type of benefit it chooses to include as part of the incentive program. Coupons specifically directed to these benefits may be dispensed to the shopper from the cart corral or from the cart at the time the cart is returned to a cart corral. The benefits may be used on the current shopping trip or during the shopper's subsequent visit to the store. The basic concept here is to increasingly reward a shopper in return for an increased degree of monitoring. By gaining data through enhanced monitoring as part of the monitoring schedule, a great deal of beneficial information can be gathered by the retailer. One way this information is used is to allow a retailer can use the information to better align store merchandise with shopper behavior.

Regardless of the embodiment of the system, during operation of the system, a shopper first removes a shopping cart from a shopping corral. At this time, the detectors read the shopper's token and the cart's tag. The token can either be a swipe card or an RFID tag. In an alternate embodiment, facial recognition technology may be used to identify the shopper. Facial recognition devices, such as cameras, can be placed at the cart corral, the store entrance, or any other location where the camera will have an unobstructed view of the shopper. These cameras will produce a video image of the shopper that matches a video image stored in a computer database. As an additional benefit, the facial recognition system can assist the retailer in identifying shoplifters who have been added to a database. Or, the facial recognition software can identify particularly loyal customers who the retailer may want to personally greet. Accordingly, the identity of the cart and shopper are communicated to the controller. The identification of the shopper will also include information related to whether the shopper has opted-in to the incentive program. Thereafter, the transceivers monitor the path of the shopping cart through the store and the amount of time a customer spends in particular areas of the store. When the shopper arrives at the point-of-sale, the scanner is used to record the goods that are to be, or have been, purchased. Further, the scanner also may be used to read the shopper's token and/or the cart's tag. During checkout at the point-of-sale, the record of the purchased goods and the identity of the shopper and/or cart are communicated to the controller that is connected to a computer. In response to the purchased goods, the shopper's purchase history, and, in some cases, to the path of the shopping cart, the controller determines suggested goods for subsequent purchase by the shopper. If the shopper participates in the incentive program, the computer will also determine eligibility for a benefit. It should be noted that the computer determines only eligibility because the shopper is given the opportunity to choose the benefit he desires. These suggested goods may be similar offerings from the suppliers and manufacturers favored by the shopper, goods previously purchased by the shopper, promotional goods, or the like.

If, after departing the store, the shopper returns the cart to a corral, the detectors acknowledge and communicate to the controller that the cart was returned. In response to this acknowledgement, the controller approves the shopper for receipt of coupons for the suggested goods, or for a benefit as part of the incentive program so long as the shopper has chosen to opt-in to the incentive program at some point. In the embodiment employing mailed coupons or benefits, the coupon dispenser prepares and sends coupons for the suggested goods or coupons for a particular benefit (like a cash payout) to the shopper via mail or email.

For a system dispensing coupons to the shopper at the time of the return of the cart, the controller again approves the shopper for receipt of coupons in response to the return of the cart. Thereafter, the coupon dispenser, mounted on the cart, the cart corral, or at the register, provides the shopper with the coupons based on an instruction from the controller.

Alternatively, for a system dispensing coupons to the shopper during a subsequent shopping visit, the controller and the computer still approve the shopper who opted-in to the incentive program for receipt of coupons for the suggested goods and other benefits in response to the return of the cart. Stated differently, the controller and the computer determine eligibility for a benefit. Further, the system may send a mail or email notification to advise the shopper of forthcoming coupons during the shopper's next visit to the store. When the shopper returns to the store during a subsequent shopping visit and retrieves a cart from the corral, the detectors communicate the identity of the shopper and the cart to the controller. At this point, the controller instructs the coupon dispenser to provide the shopper with coupons for the suggested goods. The computer can also relay a message to the coupon dispenser through the controller to inform the shopper about eligibility for a benefit. The computer and the controller work in tandem to integrate all of the information collected about the shopping trip of the shopper to determine eligibility for a benefit.

It can also be appreciated by those skilled in the trade that the system disclosed here can be used to provide an incentive for shopper behavior, beyond merely returning the shopping cart. Specifically, the system can be adapted so that the shopper can choose (opt-in) to participate in the monitoring schedule for any of various reasons and still receive benefits. As contemplated for this version of the system, the shopper can still be recognized and tracked using an RFID tag or any other type of appropriate token that can be detected by the system. Once the system has recognized that the shopper has completed the monitoring schedule, the shopper is eligible to receive a benefit that is part of the incentive program. To determine completion of the monitoring schedule, the computer or the controller can be configured to collect data related to the completion of the various tasks included as part of the monitoring schedule.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of an embodiment of a system for encouraging the return of shopping carts to a corral in accordance with the present invention;

FIG. 2 is a schematic view of the system in FIG. 1; and

FIG. 3 is a flow chart depicting the incentive system.

### DESCRIPTION OF THE PREFERRED EMBODIMENTS

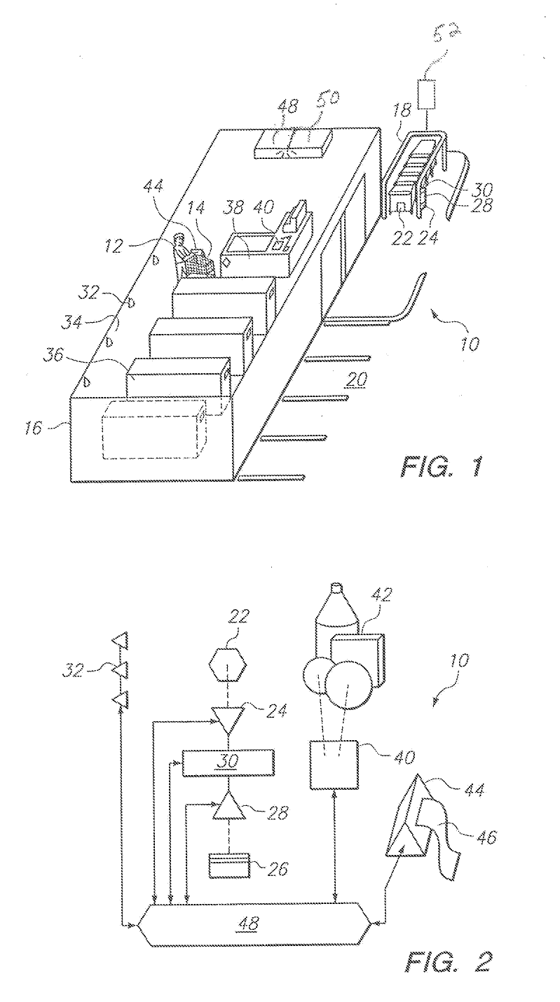

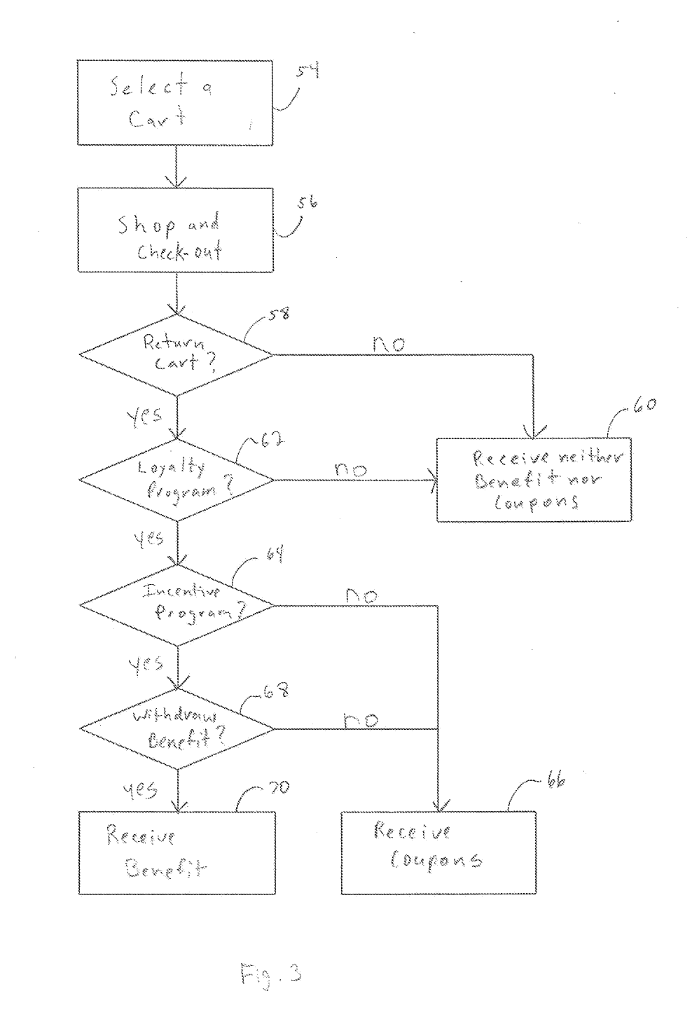

Referring initially to FIG. 1, a shopping cart accountability system is shown, and is generally designated 10. More specifically, the system 10 is used to encourage a shopper 12 to return a cart 14 after a shopping visit to a store 16. To do so, the system 10 dispenses coupons or other benefits that are part of an incentive program to the shopper 12 if the shopper 12 returns his cart 14 to a cart corral 18. To receive benefits under the incentive program, the shopper 12 must opt-in to the incentive program at some point. As shown, the store 16 includes a cart corral 18 at a parking lot 20 for receiving carts 14. In the system 10, each cart 14 is equipped with a tag 22. Further, each cart corral 18 employs a tag detector 24 that is able to read the tag 22 in order to uniquely identify, each cart 14. Preferably, the tag 22 is an RFID tag or similar device which the tag detector 24 is able to read from a distance. Further, the shopper 12 carries a token 26 (shown in FIG. 2) such as a frequent shopper card issued as part of a customer loyalty program. Or, the shopper 12 can be identified using a camera 52 provided as part of a facial recognition system. Upon initially signing up for the frequent shopper card, the shopper 12 will have the opportunity to opt-in to the incentive program. The incentive program provides the shopper 12 with increased benefits in return for enhanced monitoring and tracking of the shopper 12 during shopping trips. In order to recognize the shopper 12, the cart corral 18 also includes a token detector 28. Typically, the token 26 includes a machine readable data strip that the token detector 28 reads when the token 26 is swiped through the token detector 28. In this manner, the system 10 is able to positively identify the shopper 12.

In order to provide for an automatic response to the presence of a shopper 12, the cart corral 18 may further include an activator 30 for causing the tag detector 24 and the token detector 28 to read the tag 22 and token 26, respectively. The camera 52 can also accomplish this task if a facial recognition system is used. Although shown at a single location, the system 10 preferably employs a plurality of corrals 18, with corrals 18 located throughout the parking lot 20. In this case, a plurality of cameras 52 would also be provided if a facial recognition system is used. Further, the system 10 could include specialized return corrals 18 that are in electronic communication with a central corral 18.

For the present invention, the system 10 further includes transceivers 32 that are mounted at predetermined areas within the store 16, such as on walls 34, on aisles 36, or at the point-of-sale 38. The system 10 also includes a scanner 40 at the point of sale 38 for recording the goods 42 (shown in FIG. 2) purchased by the shopper 12. Also, the system 10 provides a coupon dispenser 44 for dispensing coupons 46 (shown in FIG. 2) to the shopper 12. Although shown mounted to the cart 14 in FIG. 1, the coupon dispenser 44 may be mounted on the corral 18 or at other locations in the store 16, like at the point-of-sale 38. Further, the system 10 includes a controller 48 connected to a computer 50. As shown in FIG. 2, the controller 48 is in electronic communication with the tag detector 24, token detector 28, activator 30, transceivers 32, scanner 40 and coupon dispenser 44. Preferably, such communication is wireless, as shown in FIG. 2.

In operation of the system 10, a shopper 12 retrieves a cart 14 from the corral 18. At this time, the tag detector 24 reads the tag 22 of the selected cart 14 and the token detector 28 reads the token 26 carried by the shopper 12. Alternatively, the shopper 12 could enter a code at the corral 18. In such a case, the code is considered to be a token 26. In another embodiment, the camera 52 can identify the shopper 12. In any event, the detectors 24, 28 or the camera 52 identify the selected cart 14 and recognize the shopper 12. Immediately, the identities of the cart 14 and shopper 12 are communicated to the controller 48, which relays the information to the computer 50. The computer 50 is provided with a computer program that can then determine whether the shopper 12 has opted-in to the incentive program. Further, the computer program also tracks a shopper's eligibility for benefits as part of the incentive program.

As the shopper 12 directs the cart 14 through the store 16, the transceivers 32 monitor and document the path of the cart 14 and the shopper 12. Accordingly, the path of the cart 14 is communicated to the controller 48 if the shopper 12 has opted-in to the enhanced monitoring required for participation in the incentive program. When the shopper 12 proceeds to check out at the point-of-sale 38, the goods 42 are scanned by the scanner 40. Again, the identity of the goods 42 is communicated to the controller 48. In response to the purchased goods 42 and/or the path traveled by the cart 14, the controller 48 determines suggested goods for future purchase by the shopper 12. And, the computer 50 also calculates eligibility for a benefit under the incentive program.

After the shopper 12 has unloaded the cart 14, the shopper 12 returns the cart 14 to a corral 18. At this time, the activator 30 senses the return of the cart 14 and causes the detectors 24, 28 to identify the cart 14 and shopper 12. Then, the detectors 24, 28 communicate to the controller 48 that the shopper 12 successfully returned the cart 14 to the corral 18. If the shopper 12 is not part of the incentive program, the controller 48 only creates coupons 46 for the suggested goods. On the other hand, if the shopper 12 is part of the incentive program, the computer 50 determines if the shopper 12 is eligible for a more substantial benefit, such as cash or a product delivered to the home of the shopper 12. Importantly, the controller 48 may be programmed to promote certain store brands of goods 42, certain goods 42 that are competitive with the purchased goods, or other goods (collectively designated 42) as desired by store management.

Depending on the system 10 employed, the coupons 46 may be mailed or emailed to the shopper 12, immediately dispensed to the shopper 12 after the return of the cart 14 from a coupon dispenser 44 mounted on the cart 14 or corral 18, or dispensed to the shopper 12 from a coupon dispenser 44 during the shopper's next visit to the store 16. Further, when the shopper 12 returns to the store 16, the detectors 24, 28 will recognize the shopper 12 and identify the cart 14 selected. The controller 48 will then instruct the coupon dispenser 44 to provide the shopper 12 with coupons 46 for the selected goods. In addition to providing the coupons 46 for particular goods, the benefits under the incentive program can be provided to the shopper 12 in the same manner. By providing coupons 46 and other benefits, the shopper 12 is rewarded for returning the cart 14 on his previous shopping visit.

Referring to FIG. 3, a flow chart is shown that illustrates what occurs when a shopper 12 selects a cart 14 and returns the cart 14 to the cart corral 18 after shopping. Prior to shopping, a shopper 12 will select a cart 14 from the cart corral 18 as shown in action block 54. The shopper 12 then shops and checks out as illustrated in action block 56. Next, the shopper 12 may or may not return the cart 14 to the cart corral 18 as shown in inquiry block 58. If the shopper 12 does not return the cart 14 to the corral 18, no benefit or coupons are dispensed as seen in action block 60. On the other hand, if the shopper 12 returns the cart 14, a signal is sent to the computer 50 via the controller 48 to indicate that the particular shopper 12 has returned the cart 14 to the corral 18. Then, as seen in inquiry block 62, the computer 50 determines whether the shopper 12 is part of the loyalty program. If the shopper 12 is not part of the loyalty program, the shopper 12 receives nothing as shown in action block 60. In the case of the shopper 12 being part of the loyalty program, the computer 50 will then determine if the shopper 12 is part of the incentive program (see inquiry block 64). If the shopper 12 is not part of the incentive program, the shopper 12 receives coupons as shown in action block 66. In the case of the shopper 12 being part of the incentive program, the shopper is given the option to withdraw a benefit at inquiry block 68. If the shopper 12 chooses to withdraw a benefit, the shopper 12 receives the benefit as shown in action block 70. If the shopper 12 chooses not to withdraw a benefit, the shopper 12 will receive coupons 66. A shopper 12 choosing not to withdraw benefits will allow a point balance to increase. The point balance can be redeemed at a later time for a more significant benefit.

While the particular System and Method for Shopping Cart Accountability Using Coupon Incentives With Participation Option as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A method for encouraging shopper compliance with an incentive program comprising the steps of:
inviting a shopper to opt-in to the incentive program, wherein the incentive program provides a benefit to the shopper in return for participation by the shopper in a monitoring schedule;
providing an electronic controller;
electronically recognizing the shopper for use of shopper recognition by the controller;
identifying the shopper as a participant in the monitoring schedule;
acknowledging participation by the shopper based on the identifying step; and
providing the shopper with the benefit in response to the acknowledging step.

2. A method as recited in claim 1 wherein the monitoring schedule of the shopper includes obtaining information about a path traveled by the shopper.

3. A method as recited in claim 2 wherein the monitoring schedule of the shopper includes determining the amount of time the shopper spends in selected areas of a store.

4. A method as recited in claim 1 wherein the benefit is selected from a group comprising a cash payment provided to the shopper, a product selected by the shopper, and a charitable donation.

5. A method as recited in claim 1 further comprising:
a computer with a computer program, wherein the computer program receives data from the controller to determine eligibility for a particular benefit under the incentive program; and
a video camera connected to the computer used to electronically recognize the shopper using a facial recognition software program loaded onto the computer.

6. A method as recited in claim 1 wherein the controller has wireless communication capability, and wherein the recognizing step is accomplished by electronically reading a token assigned to the shopper.

7. A method as recited in claim 1 further comprising the steps of:
identifying a cart used by the shopper for use of cart identification by the controller; and
acknowledging the return of the cart to a cart corral.

8. A method as recited in claim 7 wherein the acknowledging step is accomplished by sending an electronic signal from the corral to the controller.

9. A method as recited in claim 8 wherein a receiver acknowledges the cart and the shopper.

10. A method as recited in claim 3 wherein the providing step is accomplished during a subsequent shopping visit by the shopper to the store.

11. A system for encouraging shopper compliance with an incentive program comprising:
means for inviting a shopper to opt-in to the incentive program, wherein the incentive program provides a benefit to the shopper in return for participation by the shopper in a monitoring schedule;
means for providing an electronic controller;
means for electronically recognizing the shopper for use of shopper recognition by the controller;
means for electronically identifying the shopper as a participant in the monitoring schedule;
means for acknowledging participation by the shopper; and
means for providing the shopper with the benefit in response to the means for acknowledging participation by the shopper.

12. A system as recited in claim 11 further comprising means for recording the goods purchased by the shopper and sending information about the goods purchased to the electronic controller.

13. A system as recited in claim 12 further comprising means for electronically documenting a path traveled by the shopper through a store for use by the controller.

14. A system as recited in claim 11 wherein the means for electronically recognizing the shopper recognizes a cart selected by the shopper from a cart corral.

15. A system as recited in claim 11 wherein the means for providing the shopper with a benefit is a computer with a computer program, wherein the computer receives data from the electronic controller to determine eligibility of the shopper for a particular benefit.

16. A system as recited in claim 14 wherein the recognizing means includes a tag mounted on the cart and a tag receiver for reading the tag.

17. A system as recited in claim 15 wherein the means for electronically identifying the shopper is a video camera connected to the computer, wherein the video camera has a facial recognition software program used to identify the shopper using a video image produced by the video camera.

18. A system for encouraging a shopper to participate in a monitoring schedule, the system comprising:
an electronic controller;
a token detector for reading a token carried by the shopper to electronically recognize the shopper and determine shopper participation in the monitoring schedule;
an activator for causing the token detector to acknowledge a completion of the monitoring schedule by the shopper and to notify the controller of the completion; and
a means for providing the shopper with a benefit in accordance with an incentive program in response to completion of the monitoring schedule and a determination of eligibility for the benefit by the controller.

19. A system as recited in claim 18 wherein the monitoring schedule further comprises:
a means for electronically documenting a path the shopper travels while shopping; and
a means for electronically documenting an amount of time the shopper spends in selected areas of a store.

20. A system as recited in claim 18 further comprising a means for electronically identifying the shopper using a video image of the shopper and a facial recognition software program loaded onto a computer.)
